(19) United States
(12) Patent Application Publication
(10) Pub. No.: US 2018/0222352 A1
(43) Pub. Date: Aug. 9, 2018

(54) LONGITUDINAL ADJUSTING DEVICE FOR A VEHICLE SEAT

(71) Applicant: Adient Luxembourg Holding S.à.r.l., Luxembourg (LU)

(72) Inventors: Joachim FLICK, Hueckeswagen (DE); Erik SPRENGER, Wermelskirchen (DE)

(73) Assignee: Adient Luxembourg Holding S.à.r.l., Luxembourg (LU)

(21) Appl. No.: 15/749,265

(22) PCT Filed: Aug. 2, 2016
(86) PCT No.: PCT/EP2016/068358

§ 371 Date: Jan. 31, 2018

(30) Foreign Application Priority Data
Aug. 6, 2015 (DE) 10 2015 215 020.8
Oct. 8, 2015 (DE) 10 2015 219 472.8

(51) Int. Cl. B60N 2/07; B60N 2/08

(52) U.S. Cl. CPC B60N 2/0705; B60N 2/0875; B60N 2/0818; B60N 2/0727

(57) ABSTRACT

A vehicle seat longitudinal adjusting device (1) includes a rail (3.2) fixed to the vehicle and a rail (3.1) fixed to the seat, which move relative to each other. A stop (6, 7, 9, 10) protrudes in the region of a rail lock (5) and projects into an interior of the rails (3.1, 3.2). Slot-shaped rail openings (3.3) are arranged in both rails (3.1, 3.2) for locking engagement with a latching element (5.3) of a locking element (5.1) of the rail lock (5). The stop (6, 7, 9, 10) is arranged below the slot-shaped rail openings (3.3) and is narrower in the longitudinal direction (x) than the rail openings (3.3) or includes a recess (7.1) through which the latching element (5.3) can be guided. A rail pair (2) includes the longitudinal adjusting device (1) and a vehicle seat includes the rail pair (2) with the longitudinal adjusting device (1).

### CROSS REFERENCE TO RELATED APPLICATIONS

This application is a United States National Phase Application of International Application PCT/EP2016/068358 filed Aug. 2, 2016 and claims the benefit of priority under 35 U.S.C. § 119 of German Applications 10 2015 215 020.8, filed Aug. 6, 2015 and 10 2015 219 472.8, filed Oct. 8, 2015, the entire contents of which are incorporated herein by reference.

### FIELD OF THE INVENTION

The invention relates to a longitudinal adjusting device, for a vehicle seat, with at least one rail, which is fixed to the vehicle and a rail, which is fixed to the seat, the rails being longitudinally movable relative to each other, wherein in order to limit a longitudinal adjustment of at least one of the two rails at least one stop protrudes in a region of a rail lock and projects into an interior of the rails. The invention further relates to a rail pair having such a longitudinal adjusting device. The invention also relates to a vehicle seat having such a rail pair and such a longitudinal adjusting device.

### BACKGROUND OF THE INVENTION

A rail pair for longitudinally adjustable motor vehicle seats having a lower rail fixed to the body and an upper rail guided in a longitudinally displaceable manner thereon is known from the prior art. Moreover, a rail lock for locking the upper rail relative to the lower rail without clearance is known.

The document DE 10 2012 201 584 A1 discloses a seat rail arrangement having a movable rail, which is designed such that it carries a seat, and having a stationary rail, which is designed for attaching to a floor structure. The movable rail is selectively brought into a plurality of use positions relative to the stationary rail. The movable and the stationary rails contain end stop structures which cooperate in order to adapt the entire length of travel and the travel midpoint position of the movable rail relative to the stationary rail.

The document U.S. Pat. No. 7,993,060 B2 discloses a longitudinal adjusting device for a vehicle seat having a first rail which is fixed to the vehicle and a second rail which is fixed to the seat. The first rail comprises a first bent portion. The second rail comprises a pair of second bent portions which are arranged in the longitudinal direction corresponding to the first bent portion such that the mobility of the first and the second rail relative to one another in the longitudinal direction is limited by the first bent portion coming into contact with one of the second bent portions.

### SUMMARY OF THE INVENTION

It is an object of the present invention to provide an improved longitudinal adjusting device for a vehicle seat which is able to be mounted more easily and has a greater freedom of construction and a greater stability relative to a load, when the vehicle seat comes to bear in an end position, than longitudinal adjusting devices according to the prior art. An object of the present invention is also to specify an improved rail pair comprising such an improved longitudinal adjusting device and a vehicle seat having such an improved rail pair and such an improved longitudinal adjusting device.

A longitudinal adjusting device for a vehicle seat comprises at least one rail which is fixed to the vehicle and a rail which is fixed to the seat, said rails being arranged so as to be longitudinally movable relative to one another, wherein according to the invention in order to limit a longitudinal adjustment on at least one of the two rails at least one stop protrudes from the rail in the region of the rail lock and projects into an interior of the rails.

The advantages achieved by the invention, in particular, are that the interior of the rail profile and the rails is enlarged relative to conventional rails with stops on the end side, at least outside the region of the rail lock. Thus, in particular, an installation space for further components of the longitudinal adjusting device is increased due to the arrangement according to the invention and/or design of the stops.

The design of the stops according to the invention also reduces mounting effort of the longitudinal adjusting device on the vehicle seat. For example, an additional stop device and the mounting and production costs associated therewith are no longer required.

In one embodiment of the longitudinal adjusting device, the at least one stop protrudes at a predetermined angle from one of the two rails. Due to the predetermined angle of the stop, in particular, a mechanical strength is increased relative to mechanical loads acting on the stop.

Additionally, a mechanical stability of the protruding stop is increased.

A further embodiment of the longitudinal adjusting device provides that one of the two rails comprises slot-shaped rail openings for engaging with locking elements of the rail lock, wherein the stop is arranged and/or configured below the slot-shaped rail openings. This arrangement of the stop permits a space-saving alignment of the stop in the interior of the rail profile.

In a development of the longitudinal adjusting device, one of the two rails comprises at least two stops which in each case are arranged and/or configured on opposing rail sides, viewed in the longitudinal direction. By this arrangement and/or configuration of two opposing stops, in particular, the mechanical load is distributed onto the two stops.

In a further development of the longitudinal adjusting device, the stops have different dimensions. As a result, the stop strength of the wider stop is increased relative to the narrower stop.

According to one embodiment of the longitudinal adjusting device, the other of the rails comprises at least one counterstop corresponding to the stop. The counterstop protrudes on the other rail and into the interior of the rail profile. In this case, an additional mounting of a counterpart of the stop for limiting a longitudinal displacement of the rail which is fixed to the seat is avoided.

In a further embodiment of the longitudinal adjusting device a plurality of counterstops are provided, said counterstops being arranged so as to be offset to one another on opposing rail sides and in the longitudinal direction. Thus, in a position where, for example, a rail end is reached, the counterstops and the stops are configured in a simple manner so as to bear against one another. This is the case, in particular, when the stops have different dimensions in the longitudinal direction.

A further embodiment of the longitudinal adjusting device provides that the stops and/or the counterstops are configured to be arcuate. The arcuate configuration permits, in particular, the space-saving arrangement of the stops and/or counterstops in the rail profile. Additionally, the mechanical stability of the stops and/or counterstops may be increased relative to mechanical loads.

A rail pair comprising such a longitudinal adjusting device is able to be mounted, in particular, in a simple manner on the vehicle body.

The invention further relates to a vehicle seat comprising the above-described rail pair and the described longitudinal adjusting device.

Exemplary embodiments of the invention are described in more detail with reference to drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a longitudinal adjusting device having two rail pairs for a vehicle seat;

FIG. 2 is a schematic sectional view of a rail pair of the longitudinal adjusting device;

FIG. 3 is a schematic sectional view of a partial detail of the rail pair of the longitudinal adjusting device according to FIG. 2;

FIG. 4 is a schematic view from below of a rail which is fixed to the seat of the longitudinal adjusting device;

FIG. 5 is a schematic view from below of the rail pair of the longitudinal adjusting device;

FIG. 6 is a schematic view from below of the rail which is fixed to the seat of the longitudinal adjusting device in one possible embodiment;

FIG. 7 is a schematic perspective partial view of the rail which is fixed to the seat of the longitudinal adjusting device;

FIG. 8 is a schematic view from below of the rail pair of the longitudinal adjusting device; and

FIG. 9 is a schematic sectional view of the rail which is fixed to the seat of the longitudinal adjusting device.

### DESCRIPTION OF THE PREFERRED EMBODIMENTS

Referring to the drawings, parts which correspond to one another are provided in all of the Figures with the same reference numerals.

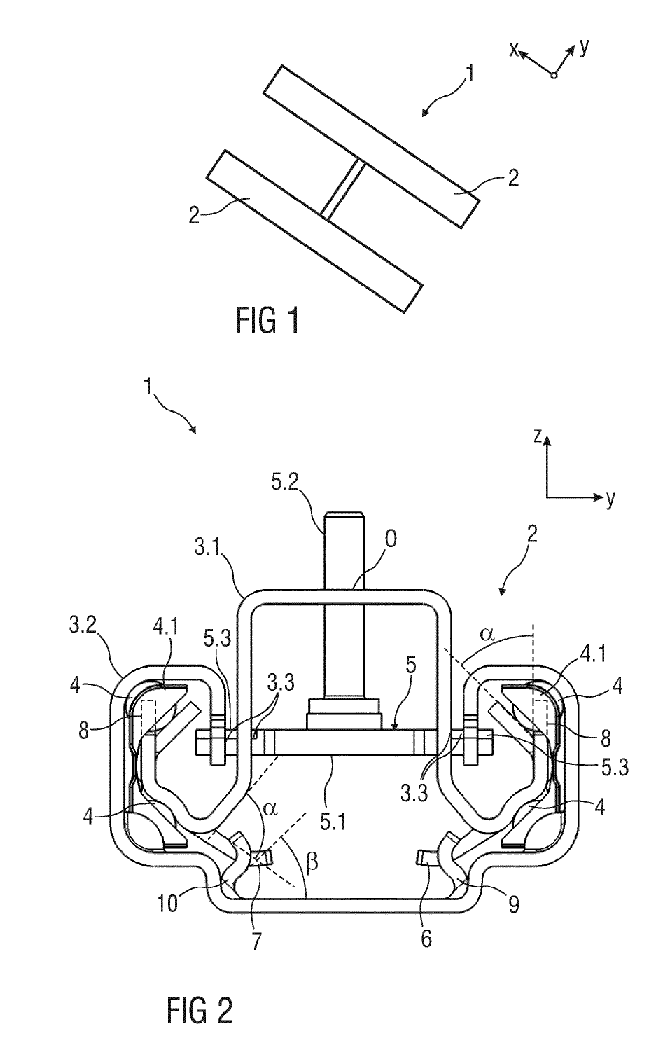

FIG. 1 shows a perspective view of a longitudinal adjusting device 1 for a vehicle seat, not shown in more detail.

The longitudinal adjusting device 1 serves for the manual longitudinal adjustment of the vehicle seat and/or for setting a seat position of the vehicle seat. In this case the longitudinal adjusting device 1 is coupled to an actuating element, not shown further, upon the actuation thereof the longitudinal adjusting device 1 permitting a displacement of the vehicle seat in the longitudinal direction x. This displacement extends substantially parallel to the direction of travel.

The vehicle seat has in each case in the longitudinal direction x on both vehicle seat sides a rail pair 2 which are coupled together for the common longitudinal adjustment.

The rail pairs 2 are constructed equally on both sides of the vehicle seat so that hereinafter for the sake of simplicity only the rail pair 2 of the longitudinal adjusting device 1 on one side is described.

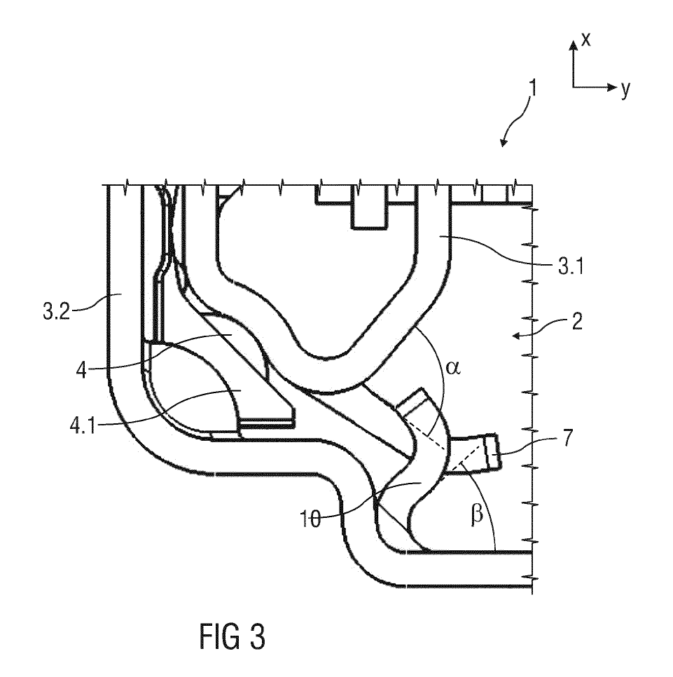

FIGS. 2 and 3 show in a sectional view the rail pair 2 of the longitudinal adjusting device 1 in the y-z plane, wherein in FIG. 3 an enlarged partial detail of the rail pair 2 is shown.

The rail pair 2 comprises a rail 3.1 which is fixed to the seat, said rail being fastened to the vehicle seat, and a rail 3.2 which is configured to be fixed to the vehicle, said rail being connected to a vehicle structure.

The rail 3.1 which is fixed to the seat and the rail 3.2 which is fixed to the vehicle are configured in each case as an upper and lower rail of the rail pair 2. In this case, the rail 3.2 which is fixed to the vehicle forms a guide rail for the rail 3.1 which is fixed to the seat and which is configured as a rail which is movable in a linear manner.

The rails 3.1, 3.2 are arranged relative to one another such that both rails 3.1, 3.2 form a rail profile with an interior and are displaceable and movable relative to one another in the longitudinal direction x. In this case, the two rails 3.1, 3.2 mutually encompass one another with their substantially U-shaped profiles, forming the rail profile and the interior.

The rail 3.1 which is fixed to the seat has in the open profile on the two limbs an edge which is repeatedly curved outwardly. The rail 3.2 which is fixed to the vehicle correspondingly has on the two limbs an edge which is repeatedly curved inwardly. The rails 3.1, 3.2 are pushed into one another such that they engage behind one another with their laterally curved edges.

In these edge regions of the rails 3.1, 3.2 balls 4 or a different suitable plain bearing are or is arranged for reducing friction between the two rails 3.1, 3.2.

In the exemplary embodiment shown, the rail pair 2 comprises two ball cages 4.1 arranged in the edge regions of the two rails 3.1, 3.2. The ball cages 4.1 may, for example, comprise recesses, not shown, which respectively receive a number of balls 4 and guide said balls at a distance from one another.

For locking the two rails 3.1, 3.2, a rail lock 5 is provided. To this end, the rail lock 5 comprises a locking element 5.1 which is arranged inside the rail profile.

The locking element 5.1 is, for example, a plate-shaped base body. Moreover, the locking element 5.1 may be designed in any manner, for example as a latching plate or a latching lever or a latching pawl. A guide pin 5.2 penetrates from the locking element 5.1 in the locking direction z upwardly through an opening O in the rail 3.1 which is fixed to the seat.

The locking element 5.1 has a number of latching elements 5.3. The latching elements 5.3 may be configured as latching teeth.

In the locked state, the locking element 5.1 engages in both rails 3.1, 3.2 by means of the latching elements 5.3 in slot-shaped rail openings 3.3 in a locking manner.

The rail lock 5 is able to be actuated by means of at least one actuating arrangement, not shown further. The actuating arrangement is configured for actuating, in particular unlocking or locking, the rail lock 5.

For limiting the longitudinal adjustment of the two rails 3.1, 3.2 to one another, stops 6, 7 are configured on the rail 3.1 which is fixed to the seat. The stops 6, 7 protrude on the rail 3.1 which is fixed to the seat in the region of the rail lock 5 and into an interior of the rail profile. Moreover, the stops 6, and 7 are of partially arcuate configuration.

For the positioning, limiting and guiding of a longitudinal displacement of the ball cages 4.1, in each case a further stop 8 is configured on the laterally curved edges of the rail 3.1 which is fixed to the seat.

The stops 6 and 8 of the rail 3.1 which is fixed to the seat in each case protrude at an angle α of 25° to 100°, in particular 35° to 90°, from the rail 3.1 which is fixed to the seat. For example, due to the predetermined angle α the mechanical stability and strength is increased relative to a mechanical load acting on the stops 6, 7 in the longitudinal direction x.

The rail 3.2 which is fixed to the vehicle comprises counterstops 9, 10 corresponding to the stops 6, 7 of the rail 3.1 which is fixed to the seat. The counterstops 9, 10 are configured to be partially arcuate and protrude from the rail 3.2 which is fixed to the vehicle and into the interior of the rail profile.

The counterstops 9, 10 protrude in this exemplary embodiment in each case at an angle β of 45° from the rail 3.2 which is fixed to the vehicle. Alternatively, the counterstops 9, 10 protrude at an angle β of 20° to 90°, in particular of 35° to 50°.

The angle α of the stops 6, 7 and the angle β of the counterstops 9, 10 are selected such that the stops 6, 7 with the counterstops 9, 10 in the rail end position bear against one another in a predetermined contact region.

Moreover, the stops 6 to 8, and/or the counterstops 9, 10 on the rail side of the respective rail 3.1, 3.2 are configured, for example, by means of stamping technology. In particular, the stops 6 to 8 and/or the counterstops 9, 10 may be partially stamped, cut and subsequently bent from the rail side. Alternatively or additionally, the stops 6 to 8 and/or the counterstops 9, 10 are configured as tabs and/or teeth. Moreover, the stops 6 to 8 and/or counterstops 9, 10 may be varied in their number, shape and width, in particular in their dimension in the longitudinal direction x.

For example, the increase in strength, in particular an increase in flexural strength and/or an increase in stability and thus a stop strength of the stops 6 to 8, is possible relative to mechanical loads and/or stresses depending on their dimensions in the longitudinal direction x. In this case, the mechanical loading and/or stress of the stops 6, 7 is understood as the longitudinal adjustment and the longitudinal displacement of the vehicle seat, if, for example, the vehicle seat is repeatedly adjusted abruptly as far as the end stop of the rails 3.1, 3.2.

In one possible embodiment, the rail 3.1 which is fixed to the seat comprises on one respective rail end two stops 8 which in each case are arranged and/or configured on opposing rail sides in the longitudinal direction x. The stops 8 may alternatively be arranged and/or configured so as to be offset to one another on the opposing rail sides. Preferably, four stops 8 are provided, respectively two opposing stops 8 for each rail end.

The width of the stops 6, 7 may be reduced to a maximum extent in comparison with conventional rails with stops on the end side, wherein the stops 6, 7 are positioned inside the region of the rail lock 5. The stops 6 are located below the slot-shaped rail openings 3.3.

An arrangement of the stops 6, 7 in the region of the rail lock 5 is able to be arranged such that the rail lock 5 is able to be mounted in a simplified manner with the locking element 5.1 and the latching elements 5.3, in particular taking into account so-called zero clearance of the rail lock 5.

In one possible embodiment, the stops 6 to 8 are configured as additional components which are able to be connected to the rails 3.1, 3.2 by a material bond, a force-fit and/or a form-fit. As additional components, the stops 6 to 8 and the rails 3.1, 3.2 may differ in their material. In this case, it is advantageously possible to form the stops 6 to 8 from a harder material in order to achieve, for example, an increase in strength relative to mechanical loads.

Alternatively or additionally, the positions of the stops 6 to 8 are variable in order to simplify, for example, a mounting of further components, such as for example a mounting of the rail lock 5.

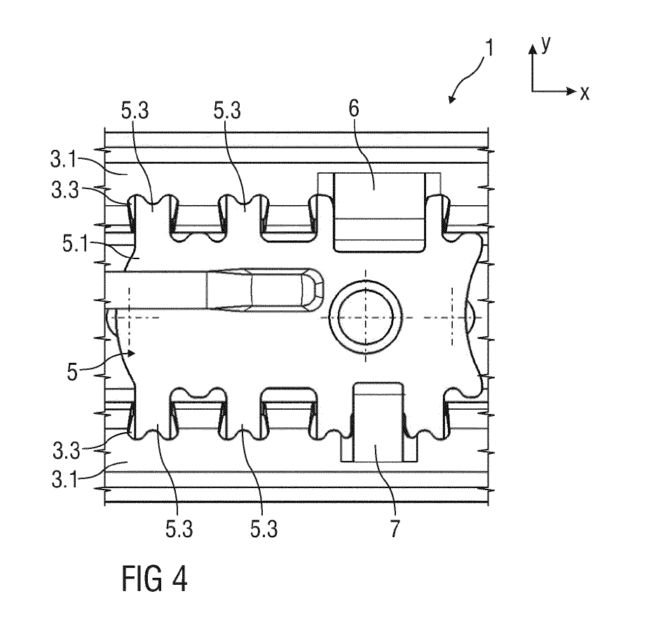

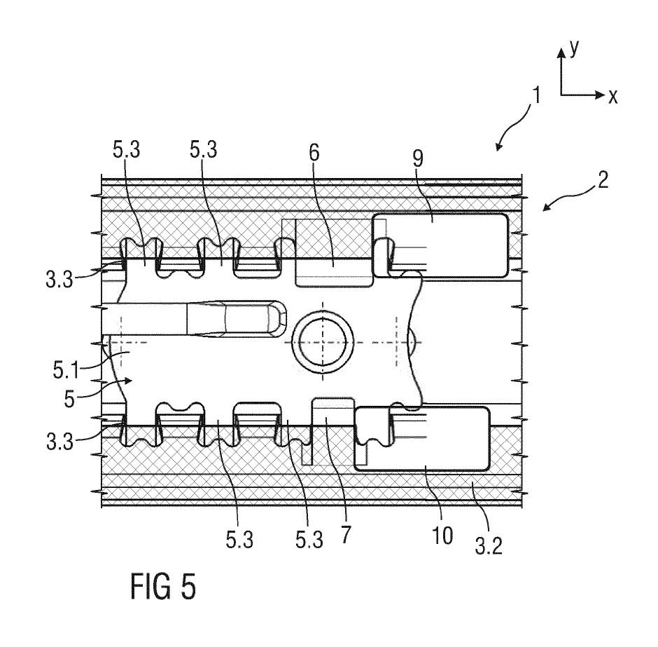

FIGS. 4 and 5 show one possible embodiment of the longitudinal adjusting device 1 in the x-y plane.

The rail 3.1 which is fixed to the seat comprises two opposing stops 6, 7, wherein the stop 6 is configured to be wider than the stop 7 in the longitudinal direction x.

The rail 3.2 which is fixed to the vehicle comprises counterstops 9, 10 which correspond to the stops 6, 7 and which are arranged offset to one another in the longitudinal direction x on the rail 3.2 which is fixed to the vehicle.

A width of the stop 7 is selected in the longitudinal direction x such that the width is smaller than the distance in the longitudinal direction x between two latching elements 5.3 of the rail lock 5.

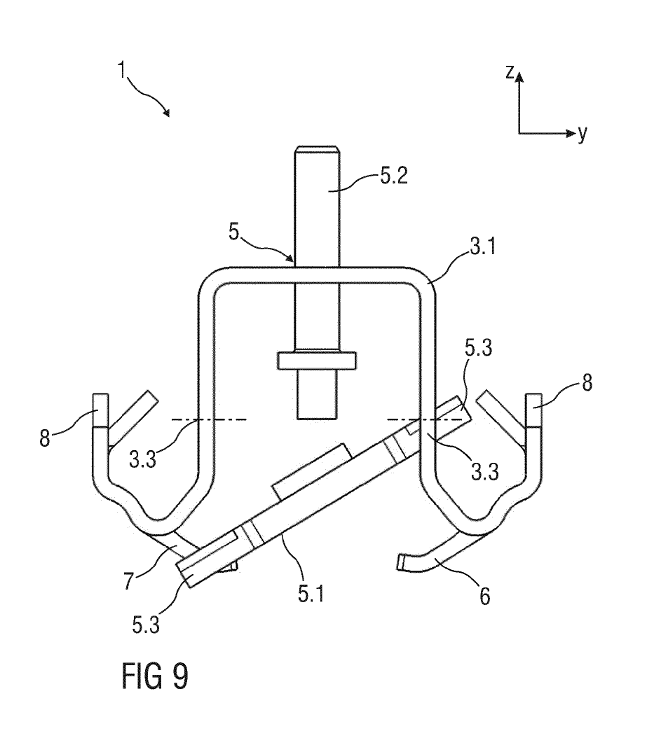

This permits a simple mounting of the rail lock 5 as shown in FIG. 9. In this case, the latching elements 5.3 of the rail lock 5 are inserted into the rail openings 3.3 above the wider stop 6 of the rail 3.1 which is fixed to the seat. Subsequently, by pivoting the locking element 5.1 of the rail lock 5 at a virtual pivot point of the rail lock 5, the latching elements 5.3 are guided past the stop 7. After the latching elements 5.3 are guided past the stop 7, the latching elements 5.3 may be inserted into the rail openings 3.3 above the stop 7.

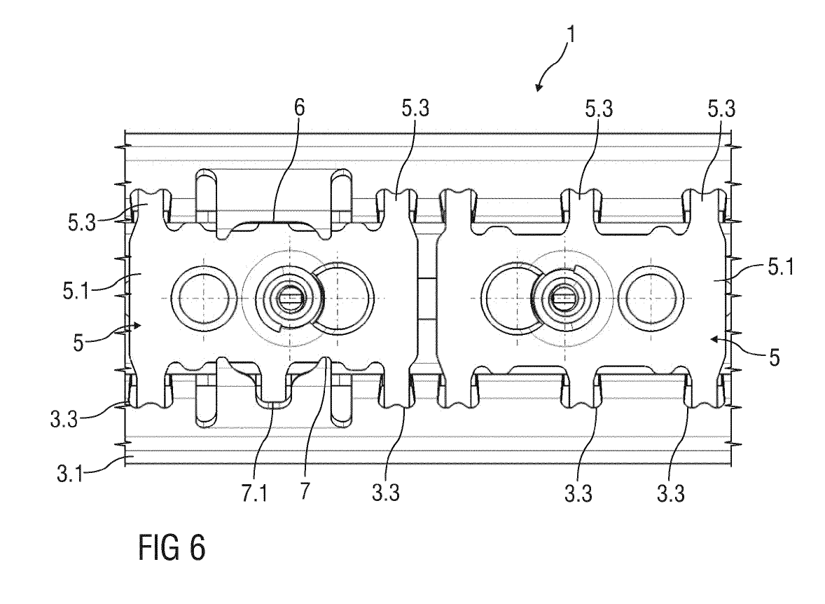

FIG. 6 shows a further embodiment of the longitudinal adjusting device 1 in the x-y plane.

The stops 6, 7 have the same dimensions in the longitudinal direction x.

For simplified mounting of the rail lock 5 the stop 7 comprises a recess 7.1, the dimensions thereof being larger in width than the width of the latching element 5.3 in the longitudinal direction x.

The recess 7.1 permits in a simple manner the mounting of the rail lock 5 shown in FIG. 9, wherein the latching elements 5.3 due to the recess 7.1 may be guided past the stop 7.

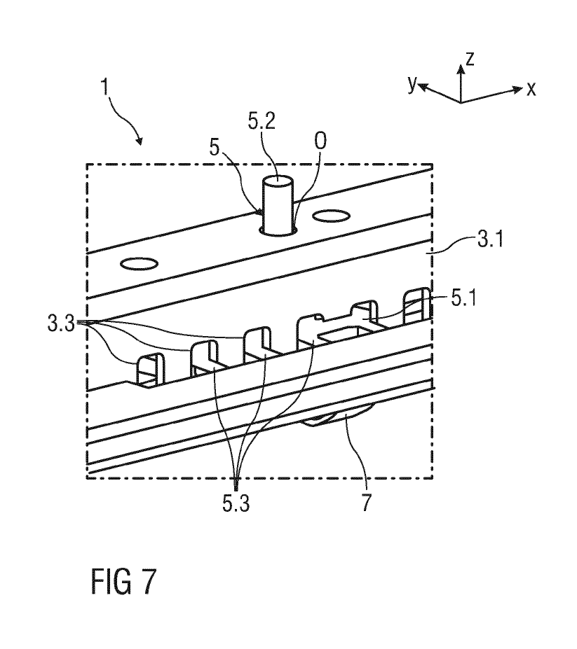

In FIG. 7, a perspective partial view of the longitudinal adjusting device 1 is shown.

The rail 3.1 which is fixed to the seat comprises a plurality of rail openings 3.3. For forming the stop 7, a portion of the rail side, on which the rail openings 3.3 are configured, is bent downwardly.

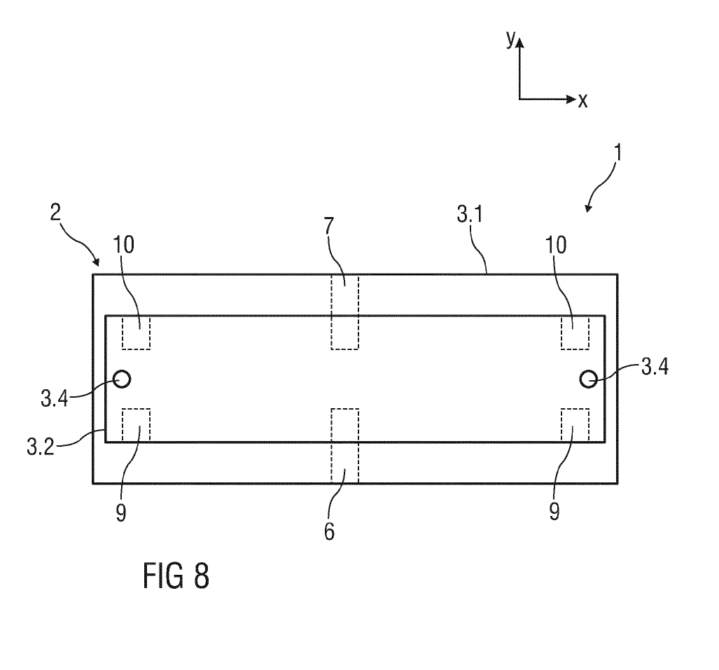

In FIG. 8, the rail pair 2 of the longitudinal adjusting device 1 is shown in the x-y plane.

The rail 3.2 which is fixed to the vehicle comprises two floor connecting screws 3.4, which in each case are arranged at a rail end of the rail 3.2 which is fixed to the vehicle. The floor connecting screws 3.4 are provided for fastening the rail 3.2 to the vehicle, said rail being fixed to the vehicle.

At both rail ends of the rail 3.2 which is fixed to the vehicle, in each case two counterstops 9, 10 are arranged on opposing rail sides.

The stops 6, 7 of the rail 3.1 which is fixed to the seat remain over the entire adjusting range between the floor connecting screws 3.4. Thus in a preferred embodiment of the stops 6, 7, at least an installation space for the floor connecting screws 3.4 may be dimensioned to a maximum extent, wherein at least a holding force is increased over the entire length of the rail 3.2 on the vehicle, said rail being fixed to the vehicle. The installation space of the floor connecting screws 3.4 is not able to be reached by the stops 6, 7.

While specific embodiments of the invention have been shown and described in detail to illustrate the application of the principles of the invention, it will be understood that the invention may be embodied otherwise without departing from such principles.

1. A longitudinal adjusting device for a vehicle seat, the longitudinal adjusting device comprising:
at least one rail which is fixed to the vehicles;
a rail which is fixed to the seat to provide two rails, said rails being longitudinally movable relative to each other;
a rail lock comprising a locking element with at least on latching element;
at least one stop to limit a longitudinal adjustment of at least one of the two rails, wherein:
the at least one stop protrudes in a region of the rail lock and projects into an interior of the rails;
slot-shaped rail openings are arranged in both rails for locking engagement with the at least one latching element
the at least one stop is arranged below the slot-shaped rail openings; and
the at least one stop is configured to be narrower in a longitudinal direction than the rail openings or the at least one stop comprises a recess through which the at least one latching element can be guided.

2. The longitudinal adjusting device as claimed in claim 1, wherein the at least one stop protrudes at a predetermined angle from one of the two rails.

3. The longitudinal adjusting device as claimed in claim 1, further comprising at least two floor connecting screws which are provided for fastening one of the two rails to the vehicle, said one of the two rails being fixed to the vehicle, said at least two floor connecting screws being arranged in an installation space which is not able to be reached by the at least one stop.

4. The longitudinal adjusting device as claimed in claim 1, wherein the rail which is fixed to the seat comprises at least two stops which in each case are arranged on opposing rail sides, viewed in the longitudinal direction.

5. The longitudinal adjusting device as claimed in claim 4, wherein the stops have different dimensions.

6. The longitudinal adjusting device as claimed in claim 1, wherein one of the rails comprises the at least one stop and the other of the rails comprises at least one counterstop to the at least one stop.

7. The longitudinal adjusting device as claimed in claim 6, wherein at least one further counterstop is provided to provide a plurality of counterstops, said counterstops being arranged offset to one another on opposing rail sides and in the longitudinal direction.

8. The longitudinal adjusting device as claimed in claim 6, wherein the stop and/or the counterstop are and/or is configured to be arcuate.

9. A rail pair comprising a longitudinal adjusting device comprising:
at least one rail which is fixed to the vehicle;
a rail which is fixed to the seat to provide two rails, said rails being longitudinally movable relative to each other;
a rail lock comprising a locking element with at least on latching element;
at least one stop to limit a longitudinal adjustment of at least one of the two rails, wherein:
the at least one stop protrudes in a region of the rail lock and projects into an interior of the rails;
slot-shaped rail openings are arranged in both rails for locking engagement with the at least one latching element;
the at least one stop is arranged below the slot-shaped rail openings; and
the at least one stop is configured to be narrower in a longitudinal direction than the rail openings or the at least one stop comprises a recess through which the at least one latching element can be guided.

10. A vehicle seat comprising a rail pair comprising a longitudinal adjusting device comprising:
at least one rail which is fixed to the vehicle;
a rail which is fixed to the seat to provide two rails, said rails being longitudinally movable relative to each other;
a rail lock comprising a locking element with at least on latching element;
at least one stop to limit a longitudinal adjustment of at least one of the two rails, wherein:
the at least one stop protrudes in a region of the rail lock and projects into an interior of the rails;
slot-shaped rail openings are arranged in both rails for locking engagement with the at least one latching element;
the at least one stop is arranged below the slot-shaped rail openings; and
the at least one stop is configured to be narrower in a longitudinal direction than the rail openings or the at least one stop comprises a recess through which the at least one latching element can be guided.

11. The vehicle seat as claimed in claim 10, wherein the at least one stop protrudes at a predetermined angle from one of the two rails.

12. The vehicle seat as claimed in claim 10, further comprising at least two floor connecting screws which are provided for fastening one of the two rails to the vehicle, said one of the two rails being fixed to the vehicle, said at least two floor connecting screws being arranged in an installation space which is not able to be reached by the at least one stop.

13. The vehicle seat as claimed in claim 10, wherein the rail, which is fixed to the seat, comprises at least two stops which in each case are arranged on opposing rail sides, viewed in the longitudinal direction.

14. The vehicle seat as claimed in claim 13, wherein the stops have different dimensions.

15. The vehicle seat as claimed in claim 10, wherein one of the rails comprises the at least one stop and the other of the rails comprises at least one counterstop to the at least one stop.

16. The vehicle seat as claimed in claim 15, wherein at least one further counterstop is provided to provide a plurality of counterstops, said counterstops being arranged offset to one another on opposing rail sides and in the longitudinal direction.

17. The vehicle seat as claimed in claim 15, wherein the stop and/or the counterstop are and/or is configured to be arcuate.
